(19) United States
(12) Patent Application Publication
(10) Pub. No.: US 2026/0245070 A1
(43) Pub. Date: Aug. 20, 2026

(54) Ephemeral Wallet

(71) Applicant: Cyphlens Inc., New York, NY (US)

(72) Inventors: Andrea G. Forte, Brooklyn, NY (US); Rocky Motwani, New York, NY (US)

(73) Assignee: Cyphlens Inc., New York, NY (US)

(21) Appl. No.: 19/053,478

(22) Filed: Feb. 14, 2025

(51) Int. Cl. G06Q 20/36; H04L 9/08

(52) U.S. Cl. CPC G06Q 20/3674; H04L 9/0861; H04L 9/088; G06Q 2220/10; H04L 2209/56

(57) ABSTRACT

A system and method implementing a digital wallet for transaction authentication using one or more ephemeral private keys. In an embodiment, a wallet application is executed on a processor and employs a remote private key storage mechanism. The processor generates an ephemeral private key for each transaction, encrypts the ephemeral private key, and embeds the ephemeral private key into an image file stored in the private key storage mechanism. One or more sensors on the electronic device detect the image file and validate it. Upon validation, the processor decrypts and extracts the ephemeral private key from the image file. A key loading processor transfers the decrypted ephemeral private key to the wallet application for transaction authentication. A memory management processor removes the decrypted ephemeral private key from active memory after the transaction is complete.

### FIELD

This invention relates to an ephemeral digital wallet system configured for secure, non-persistent storage of one or more private keys and interaction with one or more blockchain networks. The system utilizes temporary private-key encryption for transaction authentication, allowing users to send, receive, and monitor digital assets efficiently and securely.

### BACKGROUND

A blockchain wallet is a digital tool for securely storing and managing cryptocurrencies and interacting with blockchain networks. It enables sending, receiving, and tracking digital assets such as Bitcoin and Ethereum. Some blockchain wallets employ cryptographic key pairs, wherein the private key may be used to digitally sign transactions, which are subsequently broadcast to the blockchain network. The corresponding public key enables third parties to verify the authenticity of the signature, ensuring that the transaction was indeed initiated by the legitimate wallet holder. Wallet types include hot wallets, connected to the internet (e.g., web, mobile, desktop), and cold wallets, offline solutions (e.g., hardware, paper wallets), offering enhanced security for long-term storage. A physical wallet, often referred to as a “paper wallet,” is a tangible storage method for cryptocurrency keys, typically containing both public and private keys printed on paper or a QR code. While it is immune to online threats, such as hacking, due to being offline, it is vulnerable to physical damage, loss, or theft. If the wallet is destroyed or lost, access to the funds may be permanently lost. Unlike hardware wallets, which may require an external key or PIN for access, physical wallets can often be accessed by anyone with physical possession of the wallet, posing a risk of unauthorized transfer with minimal effort.

A hardware wallet, in contrast, is a physical device configured to securely store private keys offline, typically resembling a USB stick. It generates and stores private keys in a secure environment, shielding them from online threats and hacking attempts. Even when connected to a computer or mobile device for transaction signing, the keys remain isolated from the internet. Hardware wallets may be configured with additional security features such as PIN codes and recovery phrases to prevent unauthorized access. While they offer greater protection and durability compared to paper wallets, they still carry the risk of being lost or damaged, although recovery phrases provide a means of restoring access if needed.

Typically, the blockchain operates as a decentralized system, relying on a distributed network of nodes, such as computers, that collectively maintain a transaction ledger without a central authority. Each node has a copy of the blockchain, and consensus mechanisms may be implemented to facilitate transaction validity and chain integrity. This decentralization removes the need for intermediaries such as banks, allowing peer-to-peer transactions directly between participants. In implementations, many blockchain wallets come in two main forms: custodial and non-custodial. Custodial wallets are managed by third-party services, such as exchanges or wallet providers, which store and control the user's private keys. While this offers convenience for users, it also introduces security and privacy risks, as users must trust the third party to protect their keys. In contrast, non-custodial wallets give users full control over their private keys. These wallets store the keys locally on the user's device or in secure backups, ensuring that the user is the only one who can access and sign transactions. While non-custodial wallets offer greater autonomy and security, they also place the responsibility of key management on the user, meaning that if the keys are lost or not properly backed up, the user risks losing access to their funds. Both types of wallets enable interaction with the blockchain, but they differ significantly in terms of control, convenience, and user responsibility. Many wallets support multiple cryptocurrencies, facilitating management of diverse digital assets. Core functions include initiating and receiving transactions, monitoring balances and transaction history, and enabling interaction with decentralized applications (DApps).

The current state of digital wallets in the market reveals many problems related to both their functionality and security, which undermine their effectiveness in protecting users' assets. An issue is the lack of innovation and differentiation across many wallet offerings. Many digital wallets in circulation provide a standard set of features, such as basic transaction capabilities, storage for multiple types of assets, and simple user interfaces. However, these wallets do not offer specialized solutions or significant value-added features that could address the varying needs of users or offer enhanced security. For example, this lack of differentiation means that some digital wallets, whether they store a $5M non-fungible tokens (NFTs) or a modest $10 in cryptocurrency, are treated with the same level of security protocols. As a result, high-value assets are exposed to the same vulnerabilities as low-value assets, creating a risk where the security of significant financial holdings is no better than that of trivial amounts.

Typically, some current wallets manage private keys, which are the cornerstone of wallet security. The private key is typically stored within the wallet itself, whether it is on a mobile application, desktop application, or wallet plugin. This presents a potential vulnerability: as long as the private key is stored on the device, it is susceptible to theft and/or exploitation. If a user's phone or computer is compromised, whether through a malware attack, physical theft, or phishing scam, an attacker may potentially gain access to the private key and carry out transactions without the user's consent. In many cases, users unknowingly put their entire digital wealth at risk because the same device used to access their wallet is also their point of vulnerability.

Furthermore, the issue of security versus usability remains a challenge in today's digital wallet market. For example, many digital wallets are configured for ease of use, aiming to attract users with streamlined, intuitive interfaces that simplify asset management and transaction processes. However, many of these user-friendly application configurations often come at the cost of security. Simplified login systems, such as biometric authentication and/or lack of multi-factor authentication (MFA), reduce friction for users but simultaneously lower the overall security of the digital wallet. In some cases, digital wallets may allow automatic access to funds once the user's device is unlocked, making it easier for malicious actors to initiate transactions if they gain access to the user's phone, for example. While these usability features may seem convenient, they expose a dangerous flaw: they prioritize convenience over the rigorous security measures needed to protect valuable assets.

In contrast, more secure digital wallet solutions, such as wallet plugins often require multiple levels of authentication, additional external hardware, and/or a more complex setup, which can deter less tech-savvy users. As a result, users are faced with a dilemma: they can either choose highly secure wallets that are more complicated and less user-friendly or opt for simpler, more convenient wallets that offer less protection. This trade-off between security and usability results in a fragmented market where many users remain exposed to significant risks without an easy-to-use yet secure solution. The current state of digital wallets is marked by poor differentiation, weak security measures, and a challenging balance between usability and security. The uniformity of wallet offerings fails to address the diverse needs of users, leaving high-value assets vulnerable to the same threats as low-value holdings. The constant presence of private keys within the wallet itself creates serious risks, and the market's emphasis on convenience often sacrifices the robust security measures necessary for protecting user assets.

### SUMMARY

The present invention addresses the aforementioned issues, along with other limitations of prior art, by introducing a system and method implementing a digital wallet for transaction authentication using one or more ephemeral private keys. In an embodiment, a wallet application is executed on a processor and employs a remote private key storage mechanism. The processor generates an ephemeral private key for each transaction, encrypts the ephemeral private key, and embeds the ephemeral private key into an image file stored in the private key storage mechanism.

One or more sensors on the electronic device detect the image file and validate it. Upon validation, the processor decrypts and extracts the ephemeral private key from the image file. A key loading processor transfers the decrypted ephemeral private key to the wallet application for transaction authentication. A memory management processor removes the decrypted ephemeral private key from active memory after the transaction is complete.

In some aspects, the techniques described herein relate to a digital wallet system for transaction authentication with one or more ephemeral private keys, the system including: a wallet application executed at a processor of an electronic device; a private key storage mechanism located remote from the wallet application; the processor to execute instructions to: generate an ephemeral private key when one or more transactions are initiated; rendering the ephemeral private key non-persistent; encrypt the ephemeral private key; embed the encrypted ephemeral private key into data of an image file of the private key storage mechanism; decrypt, using a decryption key, the ephemeral private key when one or more sensors of the electronic device detects the image file of the private key storage mechanism and authenticates a predetermined portion of the data of the image file; and extract the decrypted ephemeral private key; a key loading processor to load the decrypted ephemeral private key into the wallet application to authenticate the one or more transactions; and a memory management processor to terminate the decrypted ephemeral private key from active memory, based on one or more predetermined access characteristics.

In some aspects, the techniques described herein relate to a digital wallet system, wherein the wallet application to employ electronic communication between a first digital wallet having a first ephemeral private key and a second digital wallet having a second ephemeral private key; and wherein the processor to output a first asset of the first digital wallet and retain the first asset within the second digital wallet, based on authentication of the image file of the first digital wallet and the second digital wallet.

In some aspects, the techniques described herein relate to a digital wallet system, wherein the image file of the private key storage mechanism is selected from a glyph, a quick-response (QR) code, or a barcode.

In some aspects, the techniques described herein relate to a digital wallet system, wherein the predetermined portion of the data of the image file is selected from at least a header of the image file, pixel data, or metadata.

In some aspects, the techniques described herein relate to a digital wallet system, wherein the one or more transactions is selected from sending a digital asset, receiving a digital asset, or monitoring a digital asset.

In some aspects, the techniques described herein relate to a digital wallet system, wherein the one or more predetermined access characteristics are selected from at least one of a completion of the one or more authenticated transactions, a predetermined duration of time, a predetermined date, a predetermined geographic location, or a predetermined use value of one or more ephemeral private keys.

In some aspects, the techniques described herein relate to a digital wallet system, wherein the decryption key is output to the wallet application responsive to at least one of a transaction status and an external event.

In some aspects, the techniques described herein relate to a digital wallet system, wherein the decryption key is assembled in volatile memory.

In some aspects, the techniques described herein relate to a digital wallet system, wherein the encrypted image file is decrypted using at least one cryptographic algorithm.

In some aspects, the techniques described herein relate to a digital wallet system, wherein the ephemeral private key includes at least one of a multi-signature key, key sharding implemented through Multiparty Computation (MPC), or a seed phrase.

In some aspects, the techniques described herein relate to a digital wallet system, wherein the encrypted ephemeral private key is reconstructed by the wallet application when one or more key shards from one or more wallet applications is detected by the processor, either in a single scan or in a sequence of scans by one or more sensors of one or more electronic devices.

In some aspects, the techniques described herein relate to a method, wherein the private key to be locked and unlocked on demand by one or more guests of the ephemeral digital wallet.

In some aspects, the techniques described herein relate to a method, further including: access to one or more decryption keys for decrypting the private key is granted as an outcome of an external event selected from the group consisting of a purchase of NFT, holding one or more decentralized autonomous organization (DAO) tokens, a specific cryptocurrency price condition, and the completion of a puzzle.

In some aspects, the techniques described herein relate to a method, wherein access to the private key is granted upon a combination of these external events.

In some aspects, the techniques described herein relate to a method, wherein the server stores a payment token and communicates with the ephemeral digital wallet to verify an authenticity of the transaction and decrypt a private key associated with the ephemeral digital wallet, before signing and completing the transaction.

In some aspects, the techniques described herein relate to a method, wherein the transaction is completed only after verification from the server, which is triggered by a successful decryption of a private key of the ephemeral digital wallet, and the transaction details are sent to the guest device for confirmation.

In some aspects, the techniques described herein relate to a method, wherein the encrypted private key is associated with a certificate of authenticity, such as a digital signature or certificate, which is verified before allowing the key to be loaded into the wallet.

In some aspects, the techniques described herein relate to a method, wherein the certificate of authenticity is stored in the ephemeral digital wallet as part of the image-based representation of the private key.

In some aspects, the techniques described herein relate to a method, wherein the encrypted private key is stored as a key shard, a seed phrase, or a multi-signature key, and is reconstructed for transaction signing after verifying an identity of a user of the ephemeral digital wallet.

In some aspects, the techniques described herein relate to a method, wherein the wallet system includes an access control mechanism for managing a decryption of a private key, the access control mechanism selected from the group consisting of a setting time window, a location restriction, and a transaction limit on key use.

In some aspects, the techniques described herein relate to a method, wherein access to a private key for completing the transaction is provided via a push notification from the server to the guest device, which then interacts with the wallet to decrypt the private key and finalize the transaction.

In some aspects, the techniques described herein relate to a method for ephemeral transaction handling in a digital wallet system, including: reading an encrypted ephemeral wallet key that is dynamically loaded into a digital wallet, wherein the ephemeral wallet key corresponds to a user's NFT wallet for a single transaction execution; decrypting and loading the ephemeral wallet key only when the transaction is ready to be signed; transferring ownership of an NFT through the digital wallet, using the loaded ephemeral wallet key, where the NFT is associated with a transaction, and the transfer is authorized by a user; storing the NFT wallet key within an encrypted image alongside a certificate of authenticity; allowing an auction house to decrypt the encrypted image, verify the authenticity, and execute the NFT transfer.

In some aspects, the techniques described herein relate to a system, wherein the encrypted ephemeral wallet key is a private key associated with the wallet, the private key is stored in encrypted form as an image, including glyphs, QR codes, or barcodes.

In some aspects, the techniques described herein relate to a system, wherein the digital wallet system utilizes multi-signature authorization, requiring multiple private key holders to decrypt and load wallet keys in a sequence or at once.

In some aspects, the techniques described herein relate to a system wherein the encrypted ephemeral wallet key is a private key to be reconstructed or loaded at specified times, such as within specific time windows.

In some aspects, the techniques described herein relate to a system wherein the encrypted ephemeral wallet key is a private key to be loaded at one or more physical locations, identified through geolocation data.

In some aspects, the techniques described herein relate to a system wherein the encrypted ephemeral wallet key is a private key is reconstructed or loaded only when both time-based and location-based conditions are met.

In some aspects, the techniques described herein relate to a system wherein the encrypted ephemeral wallet key is a private key is valid for a limited number of uses and becomes non-functional after exceeding that number, thereby expiring the wallet.

In some aspects, the techniques described herein relate to a system wherein the encrypted ephemeral wallet key is a private key is locked and unlocked on demand by an authorized wallet owner.

In some aspects, the techniques described herein relate to a system wherein the wallet key decryption is contingent upon a blockchain transaction, external event, or specific tokens, such as holding an NFT, DAO tokens, and/or meeting other predefined criteria.

In some aspects, the techniques described herein relate to a non-transitory computer-readable medium storing program instructions that, when executed by a computer, cause the computer to: facilitate a handoff of a transaction by scanning an ephemeral wallet key displayed on a user device, which corresponds to one or more NFT wallet keys for a transaction; transmit the ephemeral wallet key to a remote server; authenticate and decrypt the wallet key, then use it to complete the transaction, such as transferring ownership of an NFT.

In some aspects, the techniques described herein relate to a non-transitory computer-readable medium, wherein the ephemeral wallet key is valid for a single transaction, after which it becomes invalid.

In some aspects, the techniques described herein relate to a non-transitory computer-readable medium, wherein the transaction completion data involves a transfer of an NFT and includes associated metadata.

In some aspects, the techniques described herein relate to a method for managing wallet keys for a digital wallet, the method including: decrypting and loading wallet keys into an ephemeral wallet; using the wallet keys to sign transactions and execute transfers of NFTs or other assets, such as, digital or physical; removing the wallet keys from the digital wallet after the transaction is completed or after a specified period of time.—on demand, the first to decrypt can use it.

In some aspects, the techniques described herein relate to a method, wherein the wallet keys are decrypted and loaded ephemerally, meaning they are only available for the duration of a transaction and are automatically removed thereafter.

In some aspects, the techniques described herein relate to a method, wherein the wallet is configured to load a different set of wallet keys each time the wallet is opened, such that it behaves as a different wallet for each transaction.

In some aspects, the techniques described herein relate to a method, wherein the private keys are stored as encrypted data, represented as glyphs, QR codes, barcodes, or other image-based representations, for decryption and loading into the Cyphlens wallet.

In some aspects, the techniques described herein relate to a method, wherein the wallet keys are decrypted and loaded into the Cyphlens wallet before a transaction is signed and executed, and the wallet keys are removed after the transaction is completed or after a predetermined time period.

In some aspects, the techniques described herein relate to a method, wherein the wallet keys are loaded into the wallet only at specific times of the day or based on the user's location.

In some aspects, the techniques described herein relate to a method, wherein the wallet keys are loaded based on both time and location constraints, and the loading process is configurable.

In some aspects, the techniques described herein relate to a method, wherein the wallet keys to be used for a limited number of transactions, and once this number is reached, the wallet becomes unusable and can no longer be used for signing transactions.

In some aspects, the techniques described herein relate to a method, wherein the private key can only be decrypted and used once for a single transaction, thereby creating a disposable, one-time use wallet.

In some aspects, the techniques described herein relate to a method, wherein a wallet owner can lock and unlock access to the private key on demand, allowing them to control when the key can be used for transaction signing.

In some aspects, the techniques described herein relate to a method, wherein the private key is decrypted and loaded as a result of a blockchain transaction or external event, such as purchasing an NFT, holding certain tokens, or achieving a predetermined financial condition.

In some aspects, the techniques described herein relate to a method, wherein the private key is decrypted and loaded upon solving a puzzle or achieving another specified trigger, such as a combination of blockchain events, NFT purchases, or other triggers.

In some aspects, the techniques described herein relate to a method, wherein the digital wallet includes an auction house that has exclusive access to decrypt and verify wallet keys associated with NFTs and execute transfers of ownership.

In some aspects, the techniques described herein relate to a method, wherein the auction house verifies the authenticity of the wallet keys by decrypting a Cyphlens image, which includes both the NFT wallet keys and a certificate of authenticity.

In some aspects, the techniques described herein relate to a method for transaction authentication with one or more ephemeral private keys, including: executing a wallet application at a processor of an electronic device; the processor to execute instructions to: generate an ephemeral private key when one or more transactions are initiated; rendering the ephemeral private key non-persistent; encrypt the ephemeral private key; embed the encrypted ephemeral private key into data of an image file of a private key storage mechanism located remote from the wallet application; decrypt, using a decryption key, the ephemeral private key when one or more sensors of the electronic device detects the image file of the private key storage mechanism and authenticates a predetermined portion of the data of the image file; and extract the decrypted ephemeral private key; loading, via a key loading processor, the decrypted ephemeral private key into the wallet application to authenticate the one or more transactions; and terminating, via a memory management processor, the decrypted ephemeral private key from active memory, based on one or more predetermined access characteristics.

In some aspects, the techniques described herein relate to a non-transitory computer-readable medium embodying a set of executable instructions, the set of executable instructions to manipulate at least one processor to: execute a wallet application on an electronic device; generate an ephemeral private key when one or more transactions are initiated; rendering the ephemeral private key non-persistent; encrypt the ephemeral private key; embed the encrypted ephemeral private key into data of an image file of a private key storage mechanism located remote from the wallet application; decrypt, using a decryption key, the ephemeral private key when one or more sensors of the electronic device detects the image file of the private key storage mechanism and authenticates a predetermined portion of the data of the image file; and extract the decrypted ephemeral private key; load, via a key loading processor, the decrypted ephemeral private key into the wallet application to authenticate the one or more transactions; and terminate, via a memory management processor, the decrypted ephemeral private key from active memory, based on one or more predetermined access characteristics.

### BRIEF DESCRIPTION OF THE DRAWINGS

The present disclosure may be better understood and its numerous features and advantages made apparent to those skilled in the art by referencing the accompanying drawings. The use of the same reference symbols in different drawings indicates similar or identical items.

FIG. 1 shows an example of a process employing an image of an encrypted ephemeral transaction authorization token, to verify authenticity and transfer control of a transaction for completion to an authenticated user, within a digital wallet system, according to some embodiments of the present disclosure.

FIG. 2 is an illustration of a device showing an operational sequence that may be performed when employing the process of the digital wallet system of FIG. 1, according to some embodiments of the present disclosure.

FIG. 3 shows an example of a process employing an image of an encrypted ephemeral transaction authorization token, to sign and/or execute a transaction by an authenticated user, within a digital wallet system, according to some embodiments of the present disclosure.

FIG. 4 is an illustration of a device showing an operational sequence that may be performed when employing the process of the digital wallet system of FIG. 3, according to some embodiments of the present disclosure.

FIG. 5 is a block diagram illustrating a digital wallet system, according to some embodiments of the present disclosure.

FIG. 6 is a block diagram further illustrating the digital wallet system from FIG. 5, according to some embodiments of the present disclosure.

FIG. 7A is a flowchart illustrating a method, according to some embodiments of the present disclosure.

FIG. 7B is a flowchart further illustrating the method from FIG. 7A, according to some embodiments of the present disclosure.

### DETAILED DESCRIPTION

Example embodiments of the present invention will now be described with reference to the drawings. These embodiments are provided by way of explanation of the present invention, which is not intended to be limited thereto. In fact, those of ordinary skill in the art may appreciate upon reading the present specification and viewing the present drawings that various modifications and variations may be made thereto.

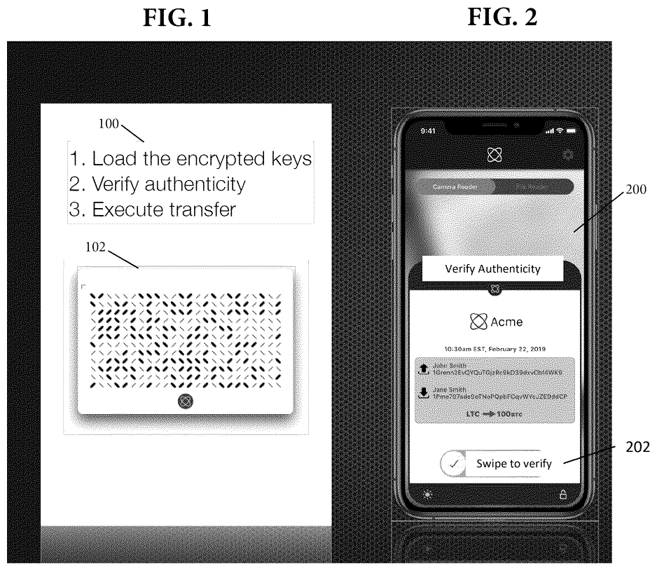

FIGS. 1-7B illustrate example methods and systems for an ephemeral digital wallet implementing transaction authentication using one or more ephemeral private keys to enable secure, non-persistent storage and interaction with one or more blockchain networks. The system employs one or more ephemeral private keys for transaction authentication, allowing users to securely send, receive, and monitor digital assets while minimizing long-term key exposure. In an embodiment, the methods and systems include a wallet application executed on a processor of an electronic device and a remote private key storage mechanism. When a transaction is initiated, the processor generates an ephemeral private key, which is rendered non-persistent and encrypted. The encrypted private key is embedded into including, but not limited to, an image file and/or a string of text stored remotely and can be decrypted when detected by a sensor on the device. The decrypted private key is then loaded into the wallet application to authenticate the transaction, after which it is removed from active memory. In some embodiments, the image file may be a glyph, QR code, or barcode, and the decryption process may involve recognizing specific portions of the data such as headers or pixel data. The system may support transactions including, but not limited to, sending, receiving, and/or monitoring assets and enforce access characteristics, such as a transaction completion or a specific time window, to control the lifecycle of the ephemeral private key. A key loading processor handles the loading of the decrypted key, while a memory management processor ensures the key is terminated after use.

The Central Processing Unit (CPU) is the hardware in a computer that executes the instructions of a computer program. Also known as a processor, the CPU performs various operations on data, including arithmetic calculations, logical comparisons, and input/output tasks.

These instructions come from software, which may also be referred to as a computer program, application, app, or code.

FIG. 1 shows an example of a process 100 employing a private key storage mechanism 102 located remote from the wallet application, such as an image of an encrypted ephemeral private key. In an example, one or more encrypted ephemeral keys may be decrypted and loaded to the wallet application to verify authenticity and execute transfer of control of a transaction to an authenticated user, within a digital wallet system.

FIG. 2 is an illustration of an electronic device 200 showing an operational sequence 202 that may be performed when employing the process 100 of the digital wallet system of FIG. 1. A prompt to verify authenticity may be displayed to a user on a graphic user interface (GUI) of a display of the electronic device 200. An icon instructs a user to “swipe to verify” the authenticity of a transaction. If authenticity is verified, a user may execute a transfer of an asset, for example.

In some embodiments, the digital ephemeral wallet is a digital wallet solution configured to enhance security by separating the wallet from the private key and using the private key ephemerally to, for example, sign one or more transactions. Unlike traditional wallets, where the private key is stored within the wallet and constantly accessible, the digital ephemeral wallet keeps the wallet and private key separate. This approach minimizes the exposure of the private key, reducing the risk of unauthorized access. The wallet employs an ephemeral key usage model, in which the private key is temporarily loaded to the wallet application to sign, in an example, high-value transactions, after which the private key is immediately removed from active memory and/or terminated. This ensures that the key is not retained in the system once the transaction is complete, providing an added layer of security.

The private key may be stored physically (“off the grid”) by printing it, allowing owner-controlled access through cold storage. This approach ensures that the key remains disconnected from any digital network until needed, protecting it from online threats. For flexibility, users can also store the key online in locations of their choice, such as email, cloud storage, and/or file-sharing services including, but not limited to, Dropbox. Although this introduces some risk compared to cold storage, it provides a convenient backup option. The wallet also allows secure sharing of the private key with trusted contacts, making it suitable for disaster recovery or post-mortem access scenarios, thereby providing a continuity plan without compromising key security. For example, the wallet enables secure distribution of the private key to trusted contacts by sharing an image file containing the encrypted private key. It further supports multi-party access by allowing authorized recipients to independently decrypt the private key and import it into their respective wallets. Additionally, the digital ephemeral wallet offers users the ability to revoke access to the key at any time, maintaining control over when and how the key is used. This may be beneficial if a potential security breach is detected and/or if temporary restrictions on access are needed. An audit trail logs key details, including who accessed the key, as well as when and where it was used, enhancing transparency and accountability by enabling a user to monitor all actions involving the private key.

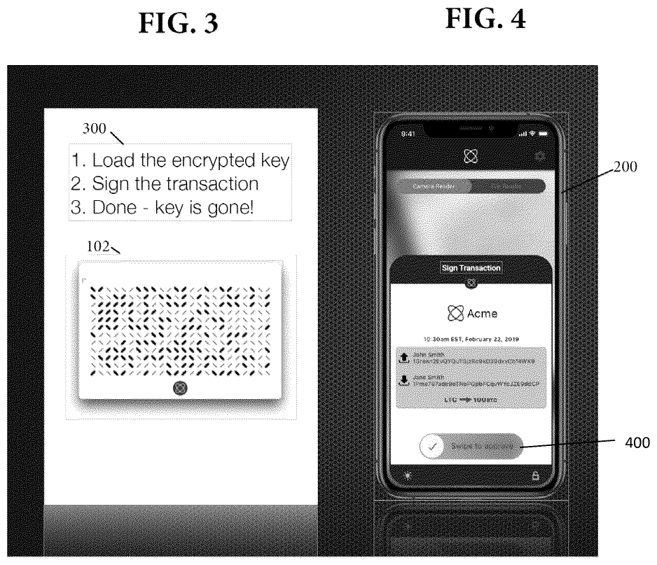

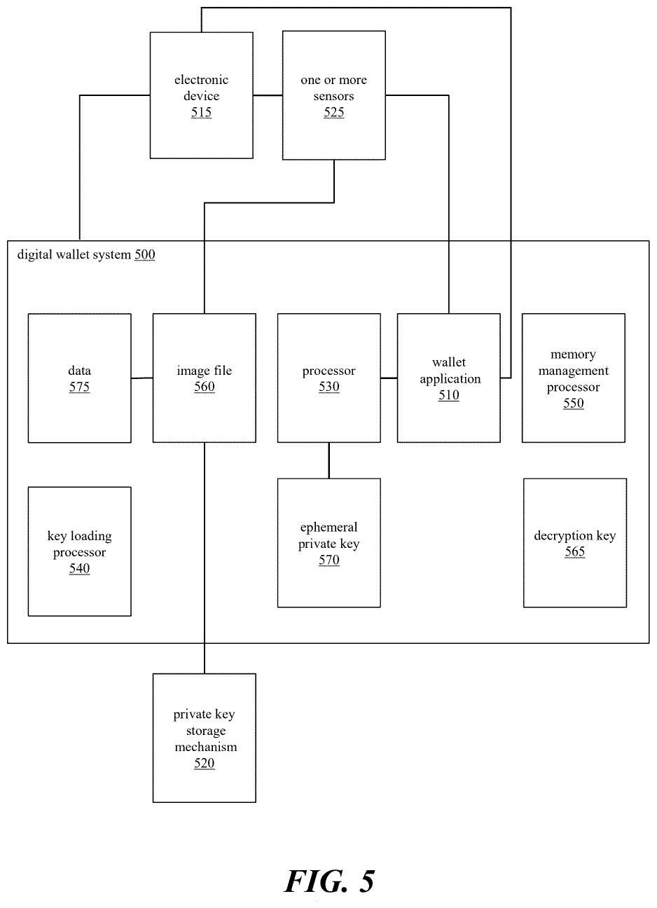

FIG. 3 shows an example of a process 300 employing the private key storage mechanism 102, of FIG. 1, located remote from the wallet application, such as an image of an encrypted ephemeral private key. For example, one or more ephemeral keys can be loaded into or reconstructed within the wallet application. The decryption steps involved in the ephemeral key loading process, are described as the description proceeds and are illustrated in FIGS. 5, 6, 7A and 7B, which enable an authenticated user to sign a transaction within the digital wallet system.

FIG. 4 is an illustration of the electronic device 200 showing an operational sequence 400 that may be performed when employing the process 300 of the digital wallet system of FIG. 3. In an example, a prompt to sign a transaction may be displayed to a user on a graphic user interface (GUI) of a display of the electronic device 200. An icon instructs a user to “swipe to approve” the transaction. As noted above, the transaction process is streamlined in three steps: loading the encrypted key, signing the authenticated transaction, and completing the process, after which the key is removed. The loading process of the encrypted key comprises a decrypting step and/or component described as the description proceeds and as illustrated in FIGS. 5, 6, 7A and 7B. The wallet's configuration, thus combines security and usability, employing a balance of ephemeral key usage, offline storage options, and controlled sharing to mitigate the vulnerabilities often associated with conventional wallets.

In an embodiment, the ephemeral wallet key, as described in the proposed method, is a transient cryptographic key utilized for the execution of a single transaction within a digital wallet, for transferring ownership of a non-fungible token (NFT). Unlike some traditional wallet systems, which may be used for ongoing access control and authentication of many transactions within a wallet, the ephemeral wallet key is dynamically generated and loaded only when the transaction is prepared for signing. This ephemeral key exists solely for the duration of the transaction and is discarded immediately after the transaction is executed, providing a layer of security by limiting the window of time during which the key is active and reducing the risk of compromise.

In the method, the ephemeral wallet key is decrypted and activated when the transaction is ready to be signed, ensuring that unauthorized access to the key is prevented during periods of inactivity. The digital wallet then uses this temporary key to authorize and complete the transfer of the NFT, which is directly associated with the specific transaction. Upon the successful transfer, the NFT wallet key, which is linked to the ownership of the NFT, is stored in an encrypted image along with a certificate of authenticity. This encrypted image, containing both the NFT wallet key and certificate, can be accessed by authorized parties, such as an auction house, which is responsible for decrypting the image to verify the authenticity of the NFT and execute the transfer. This approach enhances the security of NFT transactions by isolating the use of private keys from the transaction process and minimizing the exposure of sensitive data. The encryption and controlled decryption of the ephemeral key and associated NFT wallet key ensure that these keys are not persistently accessible, thus reducing the attack surface and improving overall transaction integrity. Moreover, the use of a certificate of authenticity embedded within the encrypted image provides a trusted mechanism for verifying the ownership and provenance of the NFT during the transfer process.

FIG. 5 is a block diagram that describes a digital wallet system 500, according to some embodiments of the present disclosure. The digital wallet system 500 implements one or more components and their interconnections for secure cryptographic operations. An electronic device 515, such as a smartphone, tablet, and/or computer, hosts the wallet application 510. This application serves as the primary interface for managing digital assets, physical assets, performing transactions, and/or interacting with cryptographic operations. The system incorporates one or more sensors 525, including, but not limited to, biometric authentication, such as fingerprint and/or facial recognition, to add an extra layer of security. A processor 530 is configured to execute cryptographic operations, manage user inputs, and/or coordinate communication between the system's components. A feature of the architecture is the use of an ephemeral private key 570, generated temporarily for specific operations, such as signing transactions. In some embodiments, this approach enhances security by limiting the exposure of long-term private keys. While ephemeral private keys are typically short-lived, they can also be implemented as long-term keys. In such cases, the ephemeral private key remains encrypted and is only decrypted and temporarily loaded into the wallet when required for specific operations. After the operation is completed, the key is securely unloaded from the wallet, reducing the risk of unauthorized access. The ephemeral key is managed alongside a private key storage mechanism 520, which securely stores one or more temporary ephemeral private keys 570.

The system also includes a key loading processor 540, responsible for retrieving and loading one or more private keys when required, and a decryption key 565 to unlock encrypted keys or related sensitive data during operations. The integration of an image file 560 facilitates the storage of one or more ephemeral private keys and/or cryptographic data may be stored in an encrypted image format, possibly leveraging steganographic techniques for enhanced protection. The memory management processor 550 employs the secure handling and temporary storage of sensitive data during cryptographic processes, while data 575 represents transaction information or metadata processed by the wallet. The system's architecture emphasizes layered security by combining temporary key generation, secure key storage, and decryption mechanisms with biometric-based authentication, in an embodiment.

In some embodiments, the digital wallet system 500 may include a wallet application 510 executed at a processor 530 of an electronic device 515. The digital wallet system 500 is configured for transaction authentication with one or more ephemeral private keys 570. A private key storage mechanism 520 is located remote from the wallet application 510. The processor 530 is configured to execute instructions to: generate an ephemeral private key 570 when one or more transactions are initiated. Private key generation typically involves the processor generating a unique private key, typically a long, random sequence of characters. In some embodiments, the set of executable instructions to manipulate the at least one processor to decrypt the encrypted image file using at least one cryptographic algorithm. In some embodiments, the at least one cryptographic algorithm may be selected from at least one of Advanced Encryption Standard (AES)or Rivest-Shamir-Adleman (RSA). This key may be encrypted using a cryptographic algorithm including, but not limited to, AES and/or RSA, with or without a password and/or other encryption keys as input, ensuring that even if the associated image file is accessed, the private key cannot be extracted without the correct decryption credentials. The encrypted data is then embedded into the pixel data or metadata of an image file, such as a PNG or JPEG, using techniques including, but not limited to, steganography may be implemented to hide the key without altering the image's visual appearance. The image file is configured to retain the encrypted key, is stored remotely from the wallet application such as on an external drive and/or in cloud storage.

This approach offers several advantages. Encryption ensures the private key remains secure and inaccessible without the decryption credentials. Embedding the ephemeral private key within an image provides obfuscation, disguising the sensitive data. Image files are portable and easily transferred across devices and/or printed, and as long as the encryption password is available, the private key can be recovered, even if the image is copied or transferred. For example, a user could encrypt their private key and embed it in a photo of a landscape, retrieving the key later by decrypting the data using the predefined password. In an embodiment, the processor 530 is configured to render the ephemeral private key non-persistent.

Typically, a private key becomes temporary when it is generated for specific, short-term use and is not stored or reused beyond its immediate purpose. This occurs in various contexts, such as secure communication protocols, one-time cryptographic operations, software testing, and/or blockchain transactions. For example, ephemeral key pairs are generated during protocols like TLS or Signal to establish secure sessions and discarded after use to ensure forward secrecy. Similarly, temporary keys may be used for one-time signing operations, testing environments, or single-use blockchain wallets to enhance security and prevent misuse. Temporary private keys are typically managed in memory only, avoiding persistent storage. The ephemeral private key may be automatically disposed of by cryptographic libraries and/or explicitly deleted from memory using secure erasure methods after use. This ensures they do not linger or risk recovery. During generation, these keys may be flagged as non-persistent and tied to specific contexts for controlled use.

The processor 530 is configured to encrypt the ephemeral private key; embed the encrypted ephemeral private key into data of an image file of the private key storage mechanism; decrypt, using a decryption key, the ephemeral private key when one or more sensors 525 of the electronic device 515 detects the image file 560 of the private key storage mechanism 520 and authenticates a predetermined portion of data 575 of the image file; and extract the decrypted ephemeral private key. As noted above, the ephemeral private key is stored as an encrypted image file on the electronic device 515 or the encrypted image file may be printed in a non-digital format, ensuring that its content cannot be decrypted without proper credentials and/or processes. Encryption typically employs one or more algorithms including, but not limited to, AES, with the encryption key derived from an authentication factor such as biometric data, a PIN, or environmental sensor data. One or more sensors 525 include, but are not limited to, cameras, biometric scanners, NFC or RFID readers, and/or touch sensors detect and activate the decryption process by identifying the physical or environmental storage mechanism (e.g., an encrypted image and/or QR code) and validating its authenticity against pre-registered patterns.

Authentication employs multi-factor methods to enhance security. After detecting the encrypted image, the user may be required to provide additional credentials, such as a password, biometric data, or mobile device approval. The device validates the image file by decrypting a portion of its header or metadata to ensure it matches an expected signature or hash, preventing unauthorized or tampered files from proceeding. In implementations, the decryption process may be initiated with key retrieval, during which the decryption key is derived from authenticated inputs and/or sensor data, such as including, but not limited to, biometric identifiers and/or environmental parameters. In implementations, the decryption key may be generated through other mechanisms, including server-side generation and subsequent transmission to the wallet via an API or similar secure communication channel. This key is generated in volatile memory and erased after use. Using this key, the device decrypts the encrypted image file and extracts the plaintext ephemeral private key. The ephemeral private key is then used for its intended purpose, such as signing a transaction, establishing a cryptographic session, and/or accessing encrypted data. Once used, the ephemeral private key is immediately removed from the wallet application, discarded, terminated, and/or rendered inoperable to maintain its temporary nature.

Additional security measures include tamper detection, where unauthorized access attempts can invalidate the key, and enforcing an ephemeral lifecycle, ensuring that the private key is valid only for the current session or transaction, requiring reauthentication and regeneration for subsequent use. A key loading processor 540 is configured to load the decrypted ephemeral private key into the wallet application 510 to authenticate the one or more transactions. A memory management processor 550 is configured to terminate the decrypted ephemeral private key from active memory, based on one or more predetermined access characteristics. A private key storage mechanism 520 is located remote from the wallet application 510. The digital wallet system 500 may also be configured to decrypt, using a decryption key, the ephemeral private key when one or more sensors of the electronic device detects the image file of the private key storage mechanism 520 and to authenticate a predetermined portion of the data of the image file. The digital wallet system 500 may also include a memory management processor 550 to terminate the decrypted ephemeral private key from active memory, based on one or more predetermined access characteristics.

In some embodiments, the image file of the private key storage mechanism 520 may be selected from a glyph, a QR code, and/or a barcode. In an embodiment, a string of text may be read and interpreted by the mobile device in a manner analogous to the reading and decoding of a glyph, a QR code, and/or a barcode. In some embodiments, the predetermined portion of the data of the image file may be selected from at least a header of the image file, pixel data, or metadata. In some embodiments, the one or more transactions may be selected from sending an asset, receiving an asset, or monitoring an asset.

In some embodiments, the one or more predetermined access characteristics may be selected from at least one of a completion of the one or more authenticated transactions, a predetermined duration of time, a predetermined date, a predetermined geographic location, or a predetermined use value of one or more ephemeral private keys. In some embodiments, the decryption key may be output to the wallet application 510 responsive to at least one of a transaction status and/or an external event.

In some embodiments, the decryption key may be assembled in volatile memory. In some embodiments, the encrypted image file may be decrypted using at least one cryptographic algorithm. In some embodiments, the digital wallet system 500 the ephemeral private key. At least one of a multi-signature key, key sharding implemented through multiparty computation (MPC), or a seed phrase. In some embodiments, the encrypted ephemeral private key may be reconstructed by the wallet application 510 when one or more key shards from one or more wallet applications may be detected by the processor, either in a single scan or in a sequence of scans by one or more sensors of one or more electronic devices.

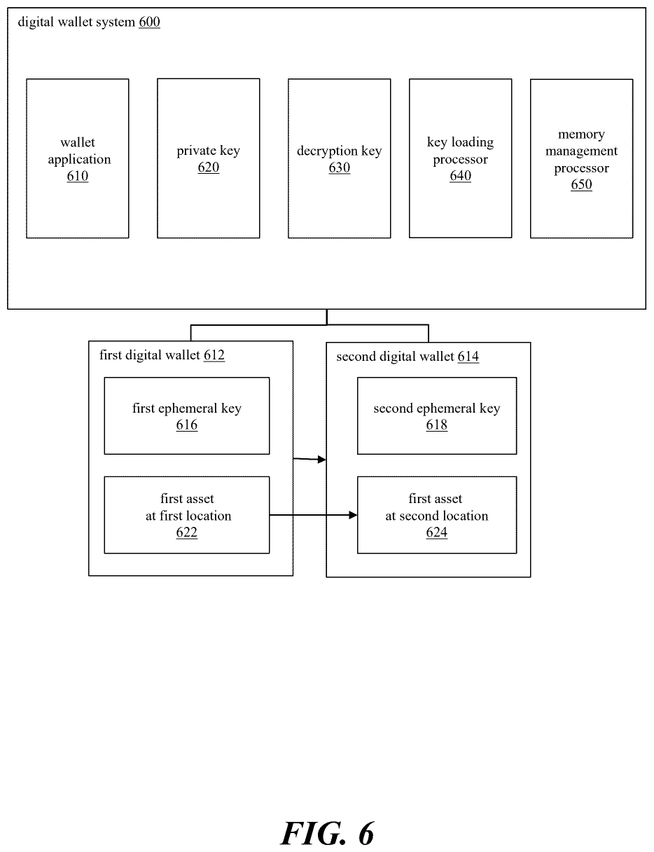

FIG. 6 is a block diagram that further describes the digital wallet system 600 from FIG. 5, according to some embodiments of the present disclosure. In some embodiments, the wallet application 610 is configured to employ electronic communication between a first digital wallet 612 with a first ephemeral key 616 and a second digital wallet 614 with a second ephemeral key 618.

The processor is configured to output a first asset of the first digital wallet 612 and retain the first asset at a first location 622 within the second digital wallet 614, based on authentication of the image file of the first digital wallet 612, to send the data, and the second digital wallet 614, to receive the data.

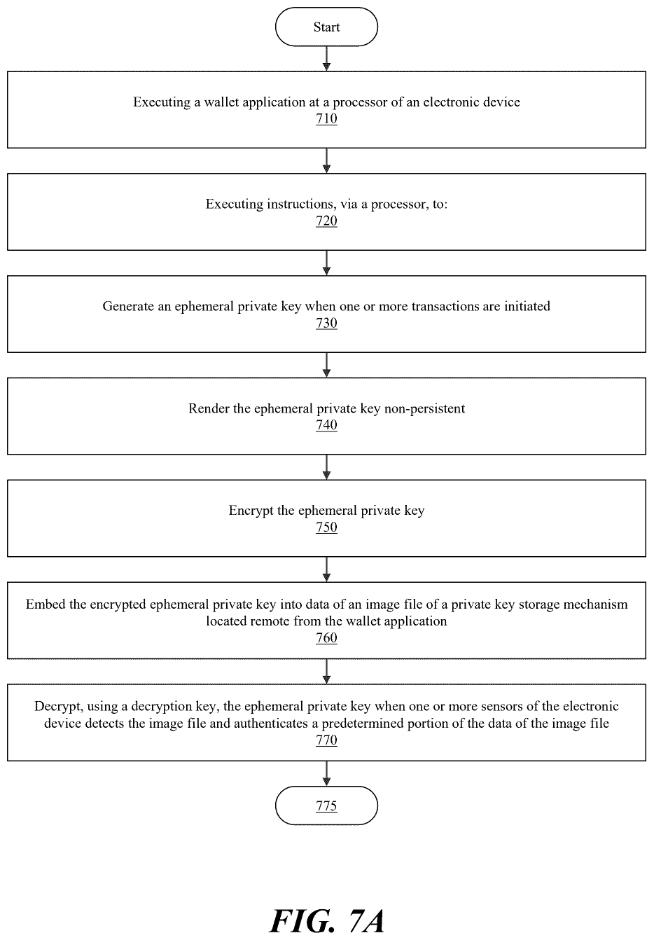

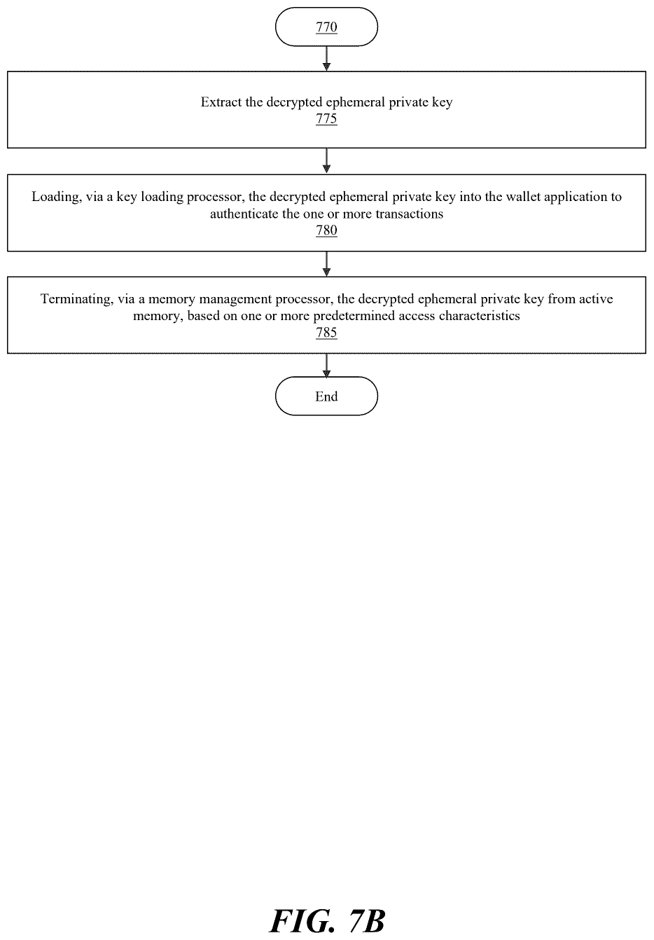

As noted above, the digital wallet system 600 facilitates the transfer of an asset between two digital wallets. The system comprises a wallet application 610 that interfaces with key management components, including a private key 620, a decryption key 630 for unlocking encrypted data, a key loading processor 640 for accessing and loading one or more ephemeral cryptographic keys, and a memory management processor 650 to securely handle data during operations. In an example, the system supports one or more digital wallets, such as two digital wallets: first digital wallet 612 and second digital wallet 614. The first wallet generates and uses a first ephemeral key 616 to initiate a transfer of a first asset at first location 622. This asset is transferred to the second wallet, after the process described in FIGS. 7A and 7B and which also uses a second ephemeral key 618 to receive and store the asset at second location 624. The process ensures secure communication and temporary key usage for enhanced security during the asset transfer.

FIG. 7A depicts a process flow for securely managing an ephemeral private key within a wallet application executed on an electronic device. At block 710, the process begins with the execution of the wallet application on the device's processor. At block 720, a processor is provided and is configured to execute a set of instructions. At block 730, the processor executes instructions to generate an ephemeral private key when one or more transactions are initiated. At block 740, the ephemeral private key is rendered non-persistent to ensure its temporary nature. At block 750, the ephemeral private key is then encrypted to enhance security. At block 760, the encrypted private key is subsequently embedded into the data of an image file associated with a private key storage mechanism that resides remotely from the wallet application. At block 770, upon detection of the image file by one or more sensors of the electronic device, the embedded ephemeral private key is decrypted using a decryption key. The image file's data is authenticated by analyzing a predetermined portion, ensuring the integrity and security of the decryption process.

FIG. 7B is a flowchart further illustrating the method from FIG. 7A. At block 775, the decrypted ephemeral private key is extracted to enable its use for subsequent processing. At block 780, the decrypted ephemeral private key is loaded into the wallet application using a key loading processor, facilitating the authentication of one or more transactions associated with the wallet application. At block 785, the decrypted ephemeral private key is terminated from active memory using a memory management processor. This termination is executed based on one or more predetermined access characteristics, ensuring that the key is removed from memory once it has fulfilled its intended purpose or after a specific condition is met, thereby enhancing the security of the system.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A digital wallet system for transaction authentication with one or more ephemeral private keys, comprising:
a wallet application executed at a processor of an electronic device;
a private key storage mechanism located remote from the wallet application;
the processor to execute instructions to:
generate an ephemeral private key when one or more transactions are initiated;
render the ephemeral private key non-persistent;
encrypt the ephemeral private key;
embed the encrypted ephemeral private key into data of an image file of the private key storage mechanism;
decrypt, using a decryption key, the ephemeral private key when one or more sensors of the electronic device detects the image file of the private key storage mechanism and authenticates a predetermined portion of the data of the image file; and
extract the decrypted ephemeral private key;
a key loading processor to load the decrypted ephemeral private key into the wallet application to authenticate the one or more transactions; and
a memory management processor to terminate the decrypted ephemeral private key from active memory, based on one or more predetermined access characteristics.

2. The digital wallet system of claim 1, wherein the wallet application to employ electronic communication between a first digital wallet having a first ephemeral private key and a second digital wallet having a second ephemeral private key; and
wherein the processor to output a first asset of the first digital wallet and retain the first asset within the second digital wallet, based on authentication of the image file of the first digital wallet and the second digital wallet.

3. The digital wallet system of claim 1, wherein the image file of the private key storage mechanism is selected from a glyph, a quick-response (QR) code, or a barcode.

4. The digital wallet system of claim 1, wherein the predetermined portion of the data of the image file is selected from at least a header of the image file, pixel data, or metadata.

5. The digital wallet system of claim 1, wherein the one or more transactions are selected from sending an asset, receiving an asset, or monitoring an asset.

6. The digital wallet system of claim 1, wherein the one or more predetermined access characteristics are selected from at least one of a completion of the one or more authenticated transactions, a predetermined duration of time, a predetermined date, a predetermined geographic location, or a predetermined use value of one or more ephemeral private keys.

7. The digital wallet system of claim 1, wherein the decryption key is output to the wallet application responsive to at least one of a transaction status and an external event.

8. The digital wallet system of claim 1, wherein the decryption key is assembled in volatile memory.

9. The digital wallet system of claim 1, wherein the encrypted image file is decrypted using at least one cryptographic algorithm.

10. The digital wallet system of claim 1, wherein the ephemeral private key comprises at least one of a multi-signature key, key sharding implemented through multiparty computation (MPC), or a seed phrase.

11. The digital wallet system of claim 1, wherein the encrypted ephemeral private key is reconstructed by the wallet application when one or more key shards from one or more wallet applications is detected by the processor, either in a single scan or in a sequence of scans by one or more sensors of one or more electronic devices.

12. A method for transaction authentication with one or more ephemeral private keys, comprising:
executing a wallet application at a processor of an electronic device;
executing instructions, via a processor, to:
generate an ephemeral private key when one or more transactions are initiated;
render the ephemeral private key non-persistent;
encrypt the ephemeral private key;
embed the encrypted ephemeral private key into data of an image file of a private key storage mechanism located remote from the wallet application;
decrypt, using a decryption key, the ephemeral private key when one or more sensors of the electronic device detects the image file of the private key storage mechanism and authenticates a predetermined portion of the data of the image file; and
extract the decrypted ephemeral private key;
loading, via a key loading processor, the decrypted ephemeral private key into the wallet application to authenticate the one or more transactions; and
terminating, via a memory management processor, the decrypted ephemeral private key from active memory, based on one or more predetermined access characteristics.

13. The method of claim 12, wherein the image file of the private key storage mechanism is selected from a glyph, a quick-response (QR) code, or a barcode.

14. The method of claim 12, wherein the predetermined portion of the data of the image file is selected from at least a header of the image file, pixel data, or metadata.

15. The method of claim 12, wherein the one or more transactions is selected from sending an asset, receiving an asset, or monitoring an asset.

16. The method of claim 12, wherein the one or more predetermined access characteristics are selected from at least one of a completion of the one or more authenticated transactions, a predetermined duration of time, a predetermined date, a predetermined geographic location, or a predetermined use value of one or more ephemeral private keys.

17. The method of claim 12, further comprising:
transmitting the decryption key to the wallet application, responsive to at least one of a transaction status or an external event.

18. A non-transitory computer-readable medium embodying a set of executable instructions, the set of executable instructions to manipulate at least one processor to:
execute a wallet application on an electronic device;
generate an ephemeral private key when one or more transactions are initiated;
render the ephemeral private key non-persistent;
encrypt the ephemeral private key;
embed the encrypted ephemeral private key into data of an image file of a private key storage mechanism located remote from the wallet application;
decrypt, using a decryption key, the ephemeral private key when one or more sensors of the electronic device detects the image file of the private key storage mechanism and authenticates a predetermined portion of the data of the image file; and
extract the decrypted ephemeral private key;
load, via a key loading processor, the decrypted ephemeral private key into the wallet application to authenticate the one or more transactions; and
terminate, via a memory management processor, the decrypted ephemeral private key from active memory, based on one or more predetermined access characteristics.

19. The computer-readable medium of claim 18, wherein the set of executable instructions to manipulate the at least one processor to decrypt the encrypted image file using at least one cryptographic algorithm.

20. The computer-readable medium of claim 19, wherein the at least one cryptographic algorithm selected from at least one of Advanced Encryption Standard (AES) or Rivest-Shamir-Adleman (RSA).
